(19) United States
(12) Patent Application Publication
(10) Pub. No.: US 2003/0193209 A1
(43) Pub. Date: Oct. 16, 2003

(54) Tonneau cover

(76) Inventor: Alberto Melvani, San Antonio, TX (US)

Correspondence Address: Soules & Wallace, P.C., Attn: Janice Leverett, Frost Bank Tower, 100 W. Houston St., Ste. 1500, San Antonio, TX, 78205, US

(21) Appl. No.: 10/121,406

(22) Filed: Apr. 12, 2002

(51) Int. Cl. B60P 7/02

(52) U.S. Cl. 296/100.02; 296/100.03

(57) ABSTRACT

A vehicular accessory for a bed of a pickup truck comprising a track system having rails incorporating grooves therein adapted to accept each side of a tonneau cover. A front end of the tonneau cover is adjacently received by a longitudinal lip extending across a forward end of the bed. Supportive ribs are attached and extend across the underbelly of the tonneau cover. A connective lock may be inserted into and through a tailgate to prevent outsiders from accessing contents held within the cavity of the pickup bed. A storage compartment is preferably attached to the tonneau cover, desirably underneath the tonneau cover, to secure and protect either smaller items or sensitive items susceptible to damage.

### TECHNICAL FIELD

The present invention relates generally to a tonneau cover; more particularly, to a tonneau cover used to protect and cover a pickup truck bed.

### BACKGROUND OF THE INVENTION

The usage of tonneau covers is known in the art, particularly in the automotive industry. Traditionally, a tonneau cover has been utilized by users to shield contents maintained within the confines of the bed of a pickup truck from the natural elements and from the public's view. Many of these covers had a shell-like configuration depicted in U.S. Pat. No. 3,201,171 (“the '171 patent”) and U.S. Pat. No. 3,606,448 (“the '448 patent”).

Specifically, the '171 patent issued to Walker in 1971 discloses a frame securable to the upper or top portion of a pickup bed side wall, and movable on the side wall to allow the frame with a cover secured thereto to collapse like an accordian. Specifically, the cover with incorporated frame includes an inverted U-shaped shell defining a compartment between the bed of the pickup and the top or upper portion of the cover.

Similar to the '171 patent, the '448 patent issued to Walker in 1971 describes a U-shaped inverted frame with a cover secured thereto designed to move on a track secured to the top of the sides of a pickup truck bed. However, the '171 and '448 devices only concentrated on bulky shell-type covers instead of a cover extending only across the sides of the pickup truck beds having no vertical wall structure above the sides of the truck.

Several attempts have been made to redesign such covers in order to reduce expense and become more market-friendly. An example of such an attempt is depicted in U.S. Pat. No. 3,342,523 (“the '523 patent”) issued to Lutgen in 1967. The '523 patent includes a sectional cover to include supports secured to truck walls. However, the amount of hardware needed to mount and secure such sectional portions of the cover did not conform to being user-friendly during assembly.

Thereafter, collapsible covers were introduced as depicted in U.S. Pat. No. 3,363,938 (“the '938 patent”) and U.S. Pat. No. 3,986,749 (“the '749 patent”). The '938 patent issued to Schultz in 1968 provides for a collapsible truck cover having a longitudinal movement with respect to the bed of a truck and which includes arched vertical supports to which the cover is secured. However, the vertical supports only led to consumer frustration due to the time spent on assembly and maintenance. As for the '749 patent issued to Hull in 1976, it discloses a collapsible cover having a track secured to the top of the side walls of a truck and a cover extending between the brackets secured to the walls of the truck. Nevertheless, the '749 patent failed to provide for a stable cover incapable of caving inward towards the cavity of the bed.

Then, in the 1980s, the tonneau covers further evolved in design and functionality. An example of such a device is depicted in U.S. Pat. No. 4,273,377 (“the '377 patent”) issued to Alexander in 1981. The '377 patent provides for a tonneau cover apparatus having an elongated track secured to the sides of a pickup truck with ribs extending across the bed and secured to bearing guides movable on the track. However, the '377 patent does not provide for a tonneau cover having ribs being incorporated onto the cover itself. Further, it fails to teach at least one longitudinal lip being mounted onto an end of the bed to prevent leaking or debris from entering the cavity of the bed.

Another example of a redesigned tonneau cover is shown in U.S. Pat. No. 4,730,866 (“the '866 patent”) issued to Nett in 1988. The '866 patent provides for a tonneau cover being releasably attached to the end and sidewalls of a pickup truck bed. Rails including opposing lateral coextensive slots are adapted to receive fastening members and secure clamp members and a cover thereto. Nevertheless, the '866 patent fails to accommodate a tool box being incorporated onto the bed of a vehicle.

Unlike, the abovementioned prior art patents, the present invention also includes at least one connective lock, preferably mounted onto the tailgate end of the cover to prevent theft and secure the cover in position. Also, the present invention incorporates a storage compartment attached to the cover, desirably on the underside of the cover. The cover further may include an aperture bored therethrough allowing the user the capability to access the cavity or storage compartment. Moreover, the present invention includes framework attached to the exterior portion of the tonneau cover in order to support skis, luggage, bicycles and the like.

In view of the above described deficiencies associated with tonneau covers, the present invention has been developed to alleviate present drawbacks and provide further benefits to a user or manufacturer. These enhancements and benefits are described in greater detail hereinbelow with respect to the embodiments of the present invention.

### SUMMARY OF THE INVENTION

The present invention in its several disclosed embodiments alleviates the drawbacks described above with respect to a vehicular accessory, namely a tonneau cover, for a bed of a pickup truck. The use of a tonneau cover is known in the prior art; however, the present invention incorporates improvements unlike the prior cited art. The present invention described herein is a tonneau cover coupled to a track system mounted onto lateral sides of the bed of a pickup truck. Specifically, two sides of the cover are accepted in corresponding rails; and a front end of the cover is received by a longitudinal lip acting as a seal. The longitudinal lip is provided to prevent leaks and other substances from coming into contact with a cavity of the bed; and prevent damage to all items stored inside the cavity. The cover has ribs operatively attached thereto to provide incorporated support and prevent buckling of the cover without having to waste time setting up a separate support system.

In a preferred embodiment, a second longitudinal lip may be mated to an edge of a tailgate end. Further, the tonneau cover may be made of transparent material to provide convenient viewing of stored items without forcing the user to manipulate the tonneau cover. The tonneau cover may also include at least one handle connected either on its exterior surface or its underside portion to aid in easy manipulation in the event the user needs to retrieve or store an item.

In the most preferred embodiment, a storage compartment is attached to the tonneau cover to protect and secure items that are valuable, perishable or delicate. Specifically, the storage compartment may be removably fastened from the tonneau cover and function as a portable pack thereafter. The storage compartment may include either a door or opening to further provide easy retrieval of items held therein. In an alternative embodiment, the tonneau cover may include an access aperture in order to allow a user to enter and exit the cavity or storage compartment in an efficient manner.

In a further embodiment, the tonneau cover is configured to accommodate a tool box affixed to the bed of a vehicle. The exterior surface of the cover may incorporate framework for carrying skis, luggage, bicycles and the like.

It is another goal of the present invention to provide for a tonneau cover that is inexpensive and easy to manufacture. The present invention is capable of being utilized for both commercial and personal use. Another advantage of the present invention is to provide a connective lock on the tailgate end in order to secure the tonneau cover therein and prevent passage into the cavity area of the bed by an outsider.

Further advantages of the invention will be more clearly understood from the following description of illustrative embodiments thereof, to be read by way of example and not of limitation in conjunction with the apparatus shown in the accompanying drawings. The beneficia effects described above apply generally to the exemplary structure disclosed herein. The specific structure and alternative embodiments utilizing these benefits will be described in detail herein below.

### BRIEF DESCRIPTION OF THE DRAWINGS

The invention will now be described in greater detail in the following way of example only and with reference to the attached drawings, in which:

FIG. 1 is a top perspective view of the present invention.

FIG. 2 is a side perspective view of the present invention.

FIG. 3 is a rearward view of a vehicle, namely a pickup truck, having the present invention incorporated therein.

FIG. 4 is a perspective view of an alternative embodiment of the present invention.

FIG. 5 is a rearward perspective view of a further alternative embodiment of the present invention accommodating a tool box being affixed to the bed of the vehicle.

FIG. 6 is a perspective view of the tonneau cover having a recess positioned on its front end

FIG. 6 is a perspective view of the tonneau cover having a recess positioned on its front end adapted to accommodate a tool box.

### MODE(S) FOR CARRYING OUT THE INVENTION

As required, detailed embodiments of the present invention are disclosed herein; however, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

Furthermore, elements may be recited as being “coupled”; this terminology's use contemplates elements being connected together in such a way that there may be other components interstitially located between the specified elements, and that the elements so specified may be connected in fixed or movable relation one to the other. The term “coupled” should be contrasted with the use of the terminology “direct” connection which designates a relationship or joinder that does not have other components interstitially located therebetween, but the components may be fixed or movable with respect to one another.

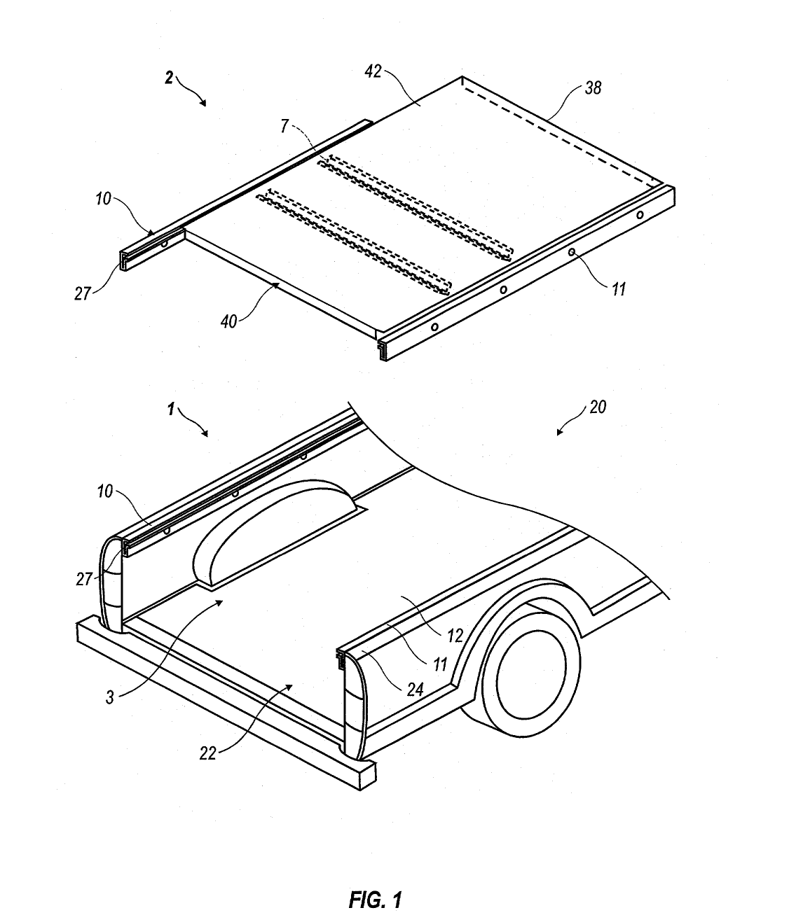

FIG. 1 illustrates a perspective view of a vehicular accessory 2 for a bed 3 of a pickup truck 1. The bed 3 collectively includes a forward end 20, a tailgate end 22 and two opposing lateral sides 24. Each opposing lateral side 24 is mated to and orthogonally extends from the forward end 20 to the tailgate end 22 peripherally defining a cavity 12 therein. The cavity 12 is designed to hold and contain contents therein ranging in shape and size. A track system is fixedly mounted to each opposing lateral side 24 of the bed 3. Specifically, the track system includes a rail 10, 11 being coextensively affixed to an upper portion of each opposing lateral side 24. Each rail 10, 11 has a lateral groove 27 designed to accept each side of a tonneau cover 27 and may incorporate apertures bored therethrough capable of receiving fasteners therein. The receiving fasteners may include, but is not limited to, pins, screws, clamps, nuts and bolts or an adhesive such as glue or an epoxy resin. Alternatively, each rail 10, 11 may be welded to its corresponding lateral side 24.

A longitudinal lip 14 is mounted to and extends across the forward end 20 of the bed 3 in order to prevent liquid or foreign substances from coming into direct contact with the cavity 12 and/or contents held within the cavity 12. The longitudinal lip 14 has a groove 29, preferably having an elongated configuration, extending in a lengthwise fashion across the lip 14. The groove 29 is adapted to receive a front end 38 of a tonneau cover 5. In a preferred embodiment, the longitudinal lip 14 upwardly and horizontally covers an edge of the front end 38 of the tonneau cover 5 and may be made of plastic, rubber, vinyl or other durable material. Preferably, the lip 14 is made of ultrahigh molecular weight (UHMW) polyethylene material being rigid in nature. Further, the longitudinal lip 14 may have a recess 33 positioned on each end in order to accommodate each corresponding end of the forward end 28 of the bed 3. In a preferred embodiment, a second longitudinal lip 36 may be operatively mated to an edge, namely an upper edge, of the tailgate end 22. The tailgate end 22 may be coupled to at least one connective lock 54 being inserted into and through the tailgate end 22. The connective lock 54 may be centrally located or positioned on one or more ends.

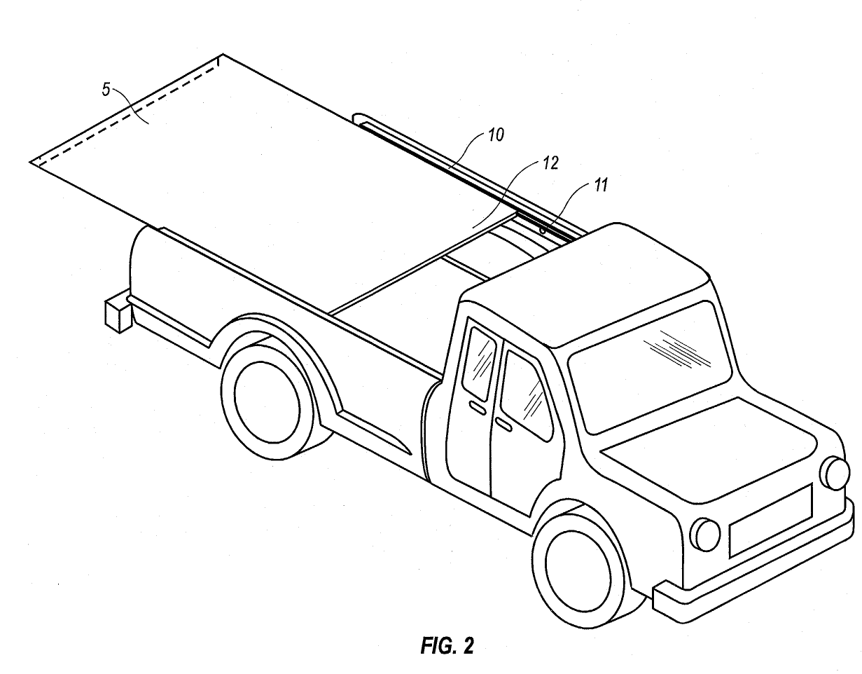

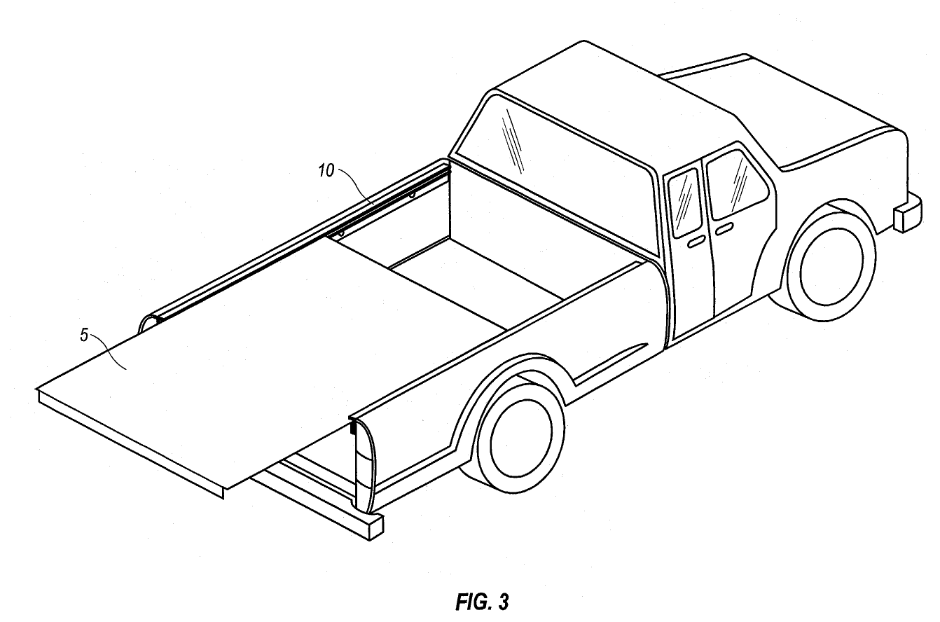

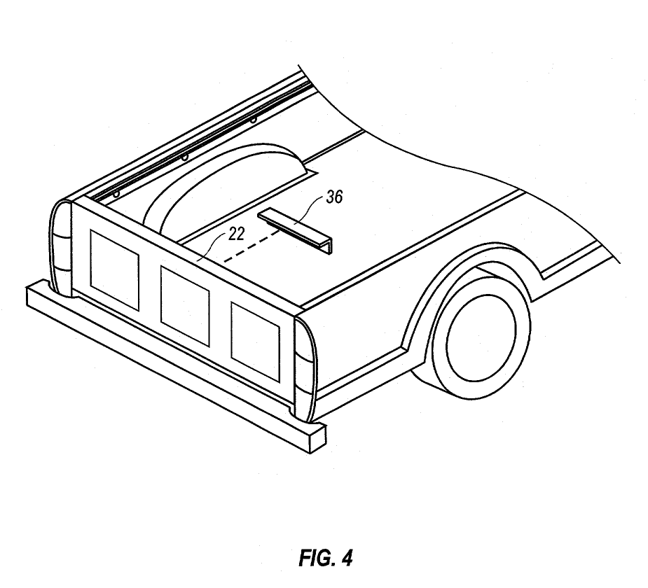

FIGS. 1, 2 and 3 show the tonneau cover 5 having a front end 38, a rear end 40 and two distal sides 42. Each distal side 42 is designed to be inserted within the lateral groove 27 of each rail 10, 11; and the front end 38 is configured to be compatibly accepted by the longitudinal lip 14. The tonneau cover 5 is made of, but not limited to, steel and aluminum materials, preferably diamond plate aluminum and stainless steel. Further, the tonneau cover 5 maybe made of transparent material for users who desire to view contents held within the cavity 12 of the bed 3 of the pickup truck 1. In a preferred embodiment, the tonneau cover 5 may include at least one handle connected either on its exterior surface or its underside portion.

Supportive ribs 7 are connectively mounted to the tonneau cover 5, preferably on an underside of the tonneau cover 5. The supportive ribs 7 may either extend horizontally, vertically or criss-cross in both a horizontal and vertical direction. Each rib 7 is either attached to the tonneau cover 5 by a fastener or is preferably welded thereto. In an embodiment, these ribs 7 may also be made of transparent material in order to correspond to a desired transparent tonneau cover 5.

A storage compartment 45 may be attached to the tonneau cover 5, preferably on the underside of the cover 5, as to protect and secure the compartment 45 within the cavity 12 of the bed 3. The storage compartment 45 includes a plurality of sides enclosing and defining an interior chamber. Specifically, the storage compartment 45 may be made of a net material, such as nylon or other mesh material or a more durable and rigid material such as steel, iron, plastic, aluminum and the like. Here, the storage compartment 45 may have one of its sides, preferably a ceiling side, defined by the tonneau cover 5. In a preferred embodiment, the storage compartment 45 is removably fastened to the tonneau cover 5 where the compartment 45 is detached from the cover 5 and may be used as a portable pack. The storage compartment 45 may further incorporate a door or opening where items contained within the chamber may be accessed. The opening may include a fastener such as Velcro, a flap, a drawstring, a zipper, buttons, snaps and the like in order to provide easy retrieval of items held therein.

In an alternative embodiment, the tonneau cover 5 may include an aperture 55 bored therethrough allowing a user to access the cavity 12 and any contents held therein. The aperture 55 further allows a user to gain access to the storage compartment 45. Here, an upper side of the storage compartment 45 is absent and instead each side wall preferably peripherally surrounds the aperture 55.

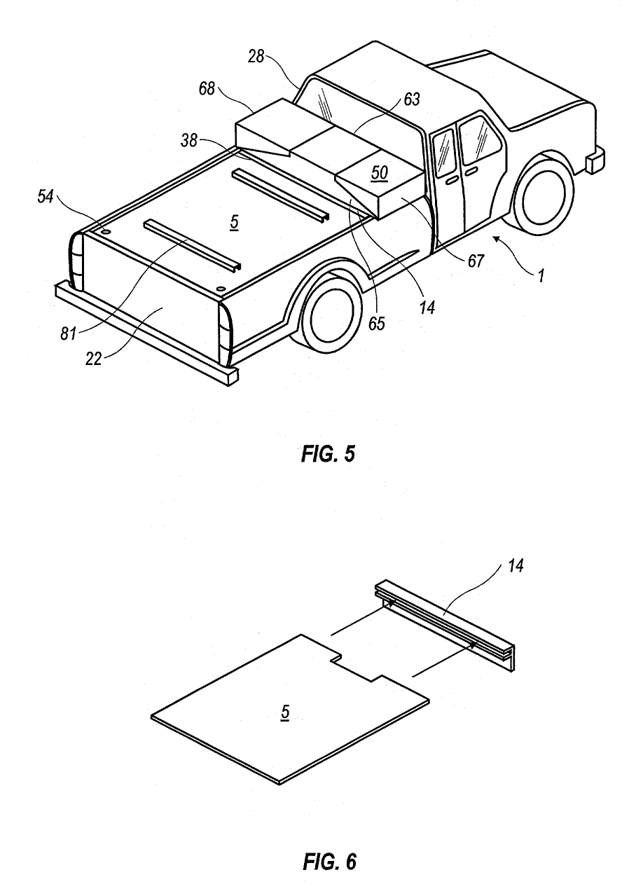

FIG. 5 depicts the bed 3 of the vehicle having a tool box adhered thereto. A first lateral side of the tool box may abut against the forward end 28 of the bed 3 or against a portion of the forward end 28. The front end 38 of the tonneau cover 5 may be adjacently positioned flush against the second lateral side of the tool box. Alternatively, the forward end 28 of the tonneau cover 5 may incorporate a customized recess in order to accommodate the configuration of the tool box. Specifically, the recess is preferably shaped and positioned to abut and surround at least one lateral side and opposing side ends of the tool box. The recess may also include a lip affixed thereon in order to prevent drainage into the cavity 12 of the bed 3. Alternatively, a flange may be fixed onto the tool box itself thereby creating an impervious seal.

The tonneau cover 5 may incorporate framework attached onto its exterior surface. The framework, whether horizontally, diagonally or vertically positioned on the cover 5, includes at least one rack capable of accepting, but is not limited to, luggage, skis, bicycle(s) and any other type of sporting items. Preferably, the framework substantially extends the length of one of the ends 20, 22 or a lateral side of the bed 3.

Industrial Applicability:

The present invention finds specific industrial applicability in the automotive accessory industry.

What is claimed and desired to be secured by Letters Patent is as follows:

1. A vehicular accessory for a bed of a pickup truck comprising:
said bed having two opposing lateral sides, a tailgate end and a forward end peripherally defining a cavity therein;
a track system comprising a rail having an incorporated lateral groove therein being mounted to an upper portion of each of said opposing sides of said bed by at least one fastener;
a longitudinal lip attached to and running across said forward end of said bed;
a tonneau cover having a front end, a rear end and two distal sides, each of said two sides are adapted to be received within said lateral grooves of said track system and said front end is capable of being accepted by said longitudinal lip; and
supportive ribs being operatively attached underneath said tonneau cover.

2. The vehicular accessory as recited in claim 1, wherein said supportive ribs extend horizontally underneath said cover.

3. The vehicular accessory as recited in claim 1, wherein said supportive ribs extend vertically underneath said cover.

4. The vehicular accessory as recited in claim 1, wherein said longitudinal lip has a groove extending lengthwise and being capable of accepting said front end of said tonneau cover therebetween.

5. The vehicular accessory as recited in claim 1, wherein said longitudinal lip upwardly and horizontally extend over an edge of said front end of said tonneau cover.

6. The vehicular accessory as recited in claim 1, wherein said supportive ribs are welded to said tonneau cover.

7. The vehicular accessory as recited in claim 1, wherein said fastener for each of said rail is selected from the group consisting of pins, screws, glue, nuts and bolts, clamps, an adhesive and a welding device.

8. The vehicular accessory as recited in claim 1, wherein said lip is made of material selected from the group consisting of plastic, rubber, vinyl and UHMW material.

9. The vehicular accessory as recited in claim 1, further comprising at least one connective lock being inserted into and through said tailgate.

10. The vehicular accessory as recited in claim 1, wherein said tonneau cover is made of a material selected from the group consisting of diamond plate aluminum, stainless steel, steel, aluminum and transparent material.

11. The vehicular accessory as recited in claim 1, further comprising a storage compartment having an opening and being attached to said tonneau cover.

12. The vehicular accessory as recited in claim 11, wherein said storage compartment has a ceiling portion defined by said tonneau cover.

13. The vehicular accessory as recited in claim 1, further comprising a second longitudinal lip extending across the rear end of the tonneau cover.

14. The vehicular accessory as recited in claim 1, wherein said longitudinal lip has a recess located on each end of said lip.

15. The vehicular accessory as recited in claim 1, wherein said supportive ribs extend in a criss-cross fashion underneath said tonneau cover.

16. The vehicular accessory as recited in claim 1, wherein said supportive ribs are made of transparent material.

17. The vehicular accessory as recited in claim 11, wherein said storage compartment is made of material selected from the group consisting of mesh, nylon, netting, steel, iron, plastic and aluminum.

18. The vehicular accessory as recited in claim 11, wherein said storage compartment is removably fastened to said tonneau cover.

19. The vehicular accessory as recited in claim 1, wherein said tonneau cover has an aperture positioned therethrough allowing access into said cavity.

20. The vehicular accessory as recited in claim 11, wherein said tonneau cover has an aperture positioned therethrough allowing access into said storage compartment.

21. The vehicular accessory as recited in claim 1, further comprising a second longitudinal lip being connected to an edge of said tailgate end of said bed.

22. The vehicular accessory as recited in claim 1, wherein said tonneau cover has at least one handle connected thereon.

23. The vehicular accessory as recited in claim 1, wherein said front end of said tonneau cover is positioned adjacent to a tool box.

24. The vehicular accessory as recited in claim 23, further comprising a recess in said front end of said tonneau cover adapted to abut and surround said tool box.

25. The vehicular accessory as recited in claim 24, wherein said recess has a lip attached thereon.

26. The vehicular accessory as recited in claim 1, further comprising at least one rack on an exterior surface of said tonneau cover capable of accepting an item thereon.
